(19) United States
(12) Patent Application Publication
(10) Pub. No.: US 2022/0146840 A1
(43) Pub. Date: May 12, 2022

(54) DISPLAY CONTROL DEVICE, AND DISPLAY CONTROL METHOD

(71) Applicant: Mitsubishi Electric Corporation, Tokyo (JP)

(72) Inventor: Shuhei OTA, Tokyo (JP)

(73) Assignee: Mitsubishi Electric Corporation, Tokyo (JP)

(21) Appl. No.: 17/433,650

(22) PCT Filed: Apr. 11, 2019
(86) PCT No.: PCT/JP2019/015815

§ 371 Date: Aug. 25, 2021

(51) Int. Cl. G02B 27/01; B60K 35/00

(52) U.S. Cl. CPC G02B 27/0179; B60K 35/00; B60K 2370/166; B60K 2370/1529; G02B 2027/0183

(57) ABSTRACT

A yawing information acquisition unit acquires a yaw angle of a vehicle. A deviation possibility prediction unit predicts a possibility of deviation of the vehicle from an expected traveling route, using at least one piece of information among line-of-sight information about an occupant, utterance information, and traffic information. A yawing change prediction unit determines deviation of the vehicle from the expected traveling route, using the yaw angle and the possibility of deviation. In a case where the yawing change prediction unit has determined the deviation, an image generation unit changes a superimposition target and corrects the difference in position between the superimposition target after the change and a display object.

### TECHNICAL FIELD

The present invention relates to a display control device and a display control method for controlling a display device for vehicles.

### BACKGROUND ART

A head-up display (hereinafter referred to as “HUD”) for vehicles is a display device that enables an occupant to visually recognize image information without significantly moving the line of sight from the front field of view. In particular, AR-HUD devices that use augmented reality (AR) can present information to occupants in a more intuitive and easier-to-understand manner than existing display devices by superimposing image information such as a route guide arrow on the foreground such as a road (see Patent Literature 1, for example).

### CITATION LIST

### Patent Literature

Patent Literature 1: JP 2018-140714 A

### SUMMARY OF INVENTION

### Technical Problem

In a case where an AR-HUD device displays a display object (a route guide arrow, for example) on a superimposition target (an intersection, for example) in the foreground, it is necessary to correct a difference in position between the superimposition target and the display object. The AR-HUD device can provide an occupant with easy-to-understand display by making the occupant visually recognize the superimposition target and the display object as if they were superimposed on each other. If the display object deviates from the superimposition target and is superimposed on another superimposition target in the foreground or is displayed in an empty space, there is a possibility that the occupant may visually recognize erroneous information. Therefore, it is important for an AR-HUD device to correct a difference in display position.

Differences in display position related to an AR-HUD device can be classified into those in the vertical direction and those in the horizontal direction. The cause of a difference in position between the superimposition target and the display object in the vertical direction is primarily a change in the road shape. For example, in a case where the position of the superimposition target is higher than the position of the vehicle due to a slope of a road, the AR-HUD device needs to correct the position of the display object upward. Further, in a case where the vehicle vibrates in the vertical direction due to unevenness of the road, the AR-HUD device needs to correct the position of the display object in the vertical direction in accordance with the superimposition target moving up and down due to the vibration of the vehicle. Patent Literature 1 teaches correction of a difference in display position in the vertical direction, but does not teach correction of a difference in display position in the horizontal direction.

The cause of a difference in position between the superimposition target and the display object in the horizontal direction is primarily the driver's vehicle operation. The driver drives a vehicle along an expected traveling route, while moving the steering wheel to right and left, and adjusting the tilt of the yaw direction of the vehicle. Therefore, even if the vehicle continues to travel in the same lane, the position of the superimposition target with respect to the vehicle in the horizontal direction changes. Therefore, the AR-HUD device needs to correct the difference in display position in the horizontal direction so that the display object continues to be superimposed on the superimposition target.

In a case where a conventional AR-HUD device corrects a difference in display position so that the display object continues to be superimposed on the superimposition target, the correction is performed on the basis of the premise that the vehicle travels in an expected traveling route, even if the vehicle sways right and left due to the driver's vehicle operation. Therefore, in a case where the vehicle moves by a greater amount than the horizontal sway caused by the driver's vehicle operation, such as at times of a lane change and obstacle avoidance, problems (1), (2), and (3) described below will occur.

(1) The display object moves in the direction opposite from the traveling direction of the vehicle, which might hinder the driving.

(2) Part or whole of the display object is not displayed in the display area of the AR-HUD device, and the information originally indicated by the display object cannot be conveyed to the occupants.

(3) When the superimposition target is changed as the vehicle keeps traveling, the display object suddenly moves onto a superimposition target after the change, which might hinder the driving.

To prevent problems such as (1), (2), and (3) mentioned above, it is necessary to detect deviation of the vehicle from the expected traveling route, and start correcting the difference in display position in the horizontal direction between the display object and the superimposition target at the start of the deviation. However, in a case where only a change in the yaw angle or the yaw rate of the vehicle is used as in a conventional AR-HUD device, it is difficult to detect the start of deviation of the vehicle from the expected traveling route.

The present invention has been made to solve the above problems, and aims to detect deviation of a vehicle from an expected traveling route, and correct a difference in position in the horizontal direction between a display object and a superimposition target in a case where the vehicle has deviated from the expected traveling route.

### Solution to Problem

A display control device according to the present invention is a display control device that controls a display device that superimposes and displays a display object on a superimposition target ahead of a vehicle. The display control device includes: a yawing information acquisition unit that acquires yawing information, the yawing information being a yaw angle that is an angle of an actual traveling direction of the vehicle with respect to an expected traveling route on which the vehicle is to travel, or a yaw rate that is an amount of change in the yaw angle per unit time; a deviation possibility prediction unit that predicts a possibility of deviation of the vehicle from the expected traveling route, using at least one piece of information among line-of-sight information about an occupant of the vehicle, utterance information about the occupant, and traffic information; a yawing change prediction unit that detects deviation of the vehicle from the expected traveling route, using the yawing information acquired by the yawing information acquisition unit, and the possibility of deviation predicted by the deviation possibility prediction unit; and an image generation unit that changes the superimposition target and corrects a difference in position between the superimposition target after the change and the display object, when the yawing change prediction unit detects deviation of the vehicle from the expected traveling route.

### Advantageous Effects of Invention

According to the present invention, deviation of a vehicle from an expected traveling route is detected with the use of a yaw angle or a yaw rate, and a deviation possibility predicted from at least one piece of information among line-of-sight information about an occupant of the vehicle, utterance information, and traffic information. In a case where deviation has been detected, the superimposition target is changed, and the difference in position between the superimposition target after the change and the display object is corrected. Thus, it is possible to correct the difference in position in the horizontal direction between the display object and the superimposition target in a case where the vehicle has deviated from the expected traveling route.

### BRIEF DESCRIPTION OF DRAWINGS

FIG. 1 is a block diagram showing the relevant parts of a display system according to a first embodiment.

FIG. 2 is a configuration diagram of the display system according to the first embodiment when installed in a vehicle.

FIG. 3 is a diagram for explaining yawing information.

FIG. 4 is a flowchart showing an example operation of a display control device according to the first embodiment.

FIG. 5A is a diagram showing the foreground from the driver's viewpoint before a lane change, and illustrates a reference example for facilitating understanding of the display system according to the first embodiment.

FIG. 5B is a diagram showing the foreground from the driver's viewpoint during the lane change, and illustrates the reference example for facilitating understanding of the display system according to the first embodiment.

FIG. 5C is a diagram showing the foreground from the driver's viewpoint after the lane change, and illustrates the reference example for facilitating understanding of the display system according to the first embodiment.

FIG. 6A is a diagram showing the foreground from the driver's viewpoint before a lane change in the display system according to the first embodiment.

FIG. 6B is a diagram showing the foreground from the driver's viewpoint during the lane change in the display system according to the first embodiment.

FIG. 6C is a diagram showing the foreground from the driver's viewpoint after the lane change in the display system according to the first embodiment.

FIG. 7 is a bird's-eye view showing the situations illustrated in FIGS. 5A and 6A.

FIG. 8 is a bird's-eye view showing the situation illustrated in FIG. 5B.

FIG. 9 is a bird's-eye view showing the situation illustrated in FIG. 6B.

FIG. 10 is a bird's-eye view showing the situations illustrated in FIGS. 5C and 6C.

FIG. 11 is a chart showing changes in yawing at a time of deviation from an expected traveling route, and is a reference example for facilitating understanding of the display system according to the first embodiment.

FIG. 12 is a chart showing changes in yawing at a time of deviation from an expected traveling route in the display system according to the first embodiment.

FIG. 13 is a diagram showing an example hardware configuration of the display system according to the first embodiment.

FIG. 14 is a diagram showing another example hardware configuration of the display system according to the first embodiment.

### DESCRIPTION OF EMBODIMENTS

To explain the present invention in greater detail, modes for carrying out the invention are described below with reference to the accompanying drawings.

### First Embodiment

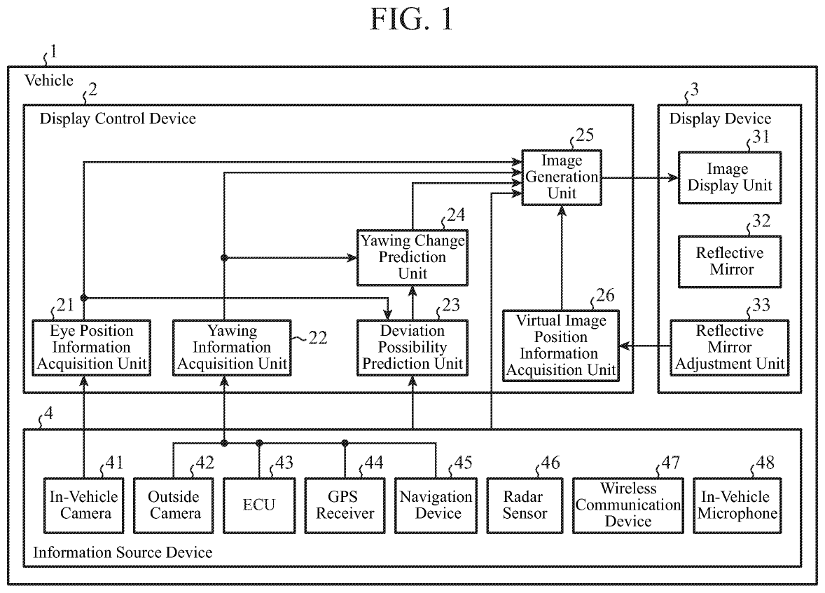

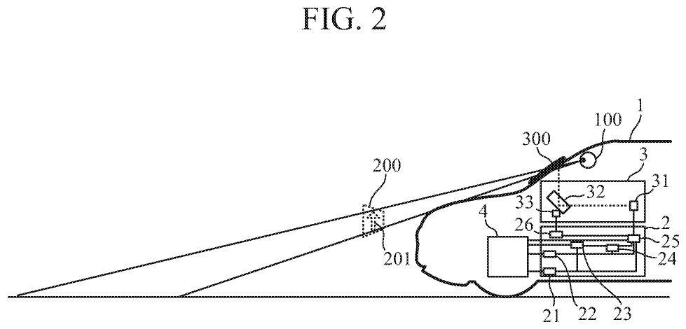

FIG. 1 is a block diagram showing the relevant parts of a display system according to a first embodiment. FIG. 2 is a configuration diagram of the display system according to the first embodiment when installed in a vehicle. As shown in FIGS. 1 and 2, a vehicle 1 is equipped with a display system including a display control device 2 and a display device 3, and an information source device 4. The display control device 2 generates image information about a display object, and the display device 3 projects display light of the image information onto a windshield 300, so that the driver can visually recognize a display object 201 in a virtual image 200 from the position of this driver's eye 100 through the windshield 300.

The display control device 2 includes an eye position information acquisition unit 21, a yawing information acquisition unit 22, a deviation possibility prediction unit 23, a yawing change prediction unit 24, an image generation unit 25, and a virtual image position information acquisition unit 26. The display control device 2 will be described later in detail.

The display device 3 includes an image display unit 31, a reflective mirror 32, and a reflective mirror adjustment unit 33.

The image display unit 31 outputs display light of image information generated by the image generation unit 25 toward the reflective mirror 32. The image display unit 31 is a display such as a liquid crystal display, a projector, or a laser light source. Note that, in a case where the image display unit 31 is a liquid crystal display, a backlight is necessary.

The reflective mirror 32 reflects display light output by the image display unit 31, and projects the display light onto the windshield 300.

The reflective mirror adjustment unit 33 adjusts the tilt angle of the reflective minor 32, to change the reflection angle of the display light output by the image display unit 31 and adjust the position of the virtual image 200. The reflective mirror adjustment unit 33 outputs reflective minor angle information indicating the tilt angle of the reflective minor 32, to the virtual image position information acquisition unit 26. In a case where the reflective mirror 32 is movable, the region in which the driver can visually recognize the virtual image 200 can be changed depending on the position of the driver's eye 100, and accordingly, the reflective minor 32 can be made smaller than a fixed type. Note that the angle adjusting method implemented by the reflective minor adjustment unit 33 may be a well-known technique, and therefore, explanation thereof is not made herein.

The windshield 300 is the surface onto which the virtual image 200 is projected. The projection target surface is not necessarily the windshield 300, but may be a semi-reflective mirror called a combiner or the like. That is, the display device 3 is not necessarily a HUD that uses the windshield 300, but may be a combiner-type HUD, a head-mounted display (HMD), or the like. As described above, the display device 3 may be any display device that superimposes and displays the virtual image 200 on the foreground of the vehicle 1.

The information source device 4 includes an in-vehicle camera 41, an outside camera 42, an electronic control unit (ECU) 43, a global positioning system (GPS) receiver 44, a navigation device 45, a radar sensor 46, a wireless communication device 47, and an in-vehicle microphone 48. This information source device 4 is connected to the display control device 2.

The in-vehicle camera 41 is a camera that captures an image of an occupant of the vehicle 1 corresponding to the observer of the virtual image 200. The display system of the first embodiment is provided on assumption that the occupant corresponding to the observer of the virtual image 200 is the driver. Therefore, the in-vehicle camera 41 captures an image of the driver.

The outside camera 42 is a camera that captures an image of the surroundings of the vehicle 1. For example, the outside camera 42 captures an image of a lane in which the vehicle 1 is traveling (hereinafter referred to as the “driving lane”), and an obstacle such as another vehicle present in the vicinity of the vehicle 1.

The ECU 43 is a control unit that controls various operations of the vehicle 1. The ECU 43 is connected to the display control device 2 with a wire harness (not shown), and can communicate freely with the display control device 2 by a communication method based on the Controller Area Network (CAN) standard. The ECU 43 is connected to various sensors (not shown), and acquires vehicle information regarding various operations of the vehicle 1 from the various sensors. The vehicle information includes information about vehicle angle, acceleration, angular velocity, vehicle velocity, steering angle, the blinkers, and the like. The angular velocity is formed with angular velocity components generated around the three axes orthogonal to the vehicle 1, which are yaw rate, pitch rate, and roll rate.

The GPS receiver 44 receives a GPS signal from a GPS satellite (not shown), and calculates position information corresponding to the coordinates indicated by the GPS signal. The position information calculated by the GPS receiver 44 corresponds to current position information indicating the current position of the vehicle 1.

The navigation device 45 corrects the current position information calculated by the GPS receiver 44, on the basis of the angular velocity acquired from the ECU 43. The navigation device 45 sets the corrected current position information as the place of departure, and searches for the traveling route of the vehicle 1 from this place of departure to a destination set by the occupant, using map information stored in a storage device (not shown). Note that, in FIG. 1, the connection line between the navigation device 45 and the GPS receiver 44, and the connection line between the navigation device 45 and the ECU 43 are not shown. The navigation device 45 outputs route guidance information to be used in the traveling route guidance to the display control device 2, and causes the display device 3 to display the route guidance information. The route guidance information includes the traveling direction of the vehicle 1 at the guidance point (an intersection, for example) on the traveling route, an estimated time of arrival at a waypoint or the destination, and traffic congestion information regarding the traveling route and the surrounding roads.

Note that the navigation device 45 may be an information device mounted in the vehicle 1, or may be a mobile communication terminal such as a portable navigation device (PDN) or a smartphone brought into the vehicle 1.

The radar sensor 46 detects the direction and the shape of an obstacle present in the vicinity of the vehicle 1, and the distance between the vehicle 1 and the obstacle. The radar sensor 46 includes a radio-frequency sensor in a millimeter waveband, an ultrasonic sensor, or an optical radar sensor, for example.

The wireless communication device 47 acquires various kinds of information by communicating with a network outside the vehicle. The wireless communication device 47 is formed with a transceiver mounted in the vehicle 1, or a mobile communication terminal such as a smartphone brought into the vehicle 1, for example. The network outside the vehicle is the Internet, for example. The various kinds of information to be acquired by the wireless communication device 47 includes weather information about the area around the vehicle 1, or facility information and the like.

The in-vehicle microphone 48 is a microphone installed in the interior of the vehicle 1. The in-vehicle microphone 48 collects conversations or utterances of occupants including the driver, and outputs them as utterance information.

Next, each component of the display control device 2 is described.

The eye position information acquisition unit 21 acquires eye position information indicating the position of the driver's eye 100, and line-of-sight information indicating the direction of the line of sight. For example, the eye position information acquisition unit 21 analyzes an image captured by the in-vehicle camera 41, detects the position of the driver's eye 100, and sets the detected position of the eye 100 as the eye position information. The position of the driver's eye 100 may be the position of each of the driver' left eye and right eye, or may be the middle position between the left eye and the right eye. Note that the eye position information acquisition unit 21 may estimate the middle position between the right eye and the left eye, from the driver's face position in an image captured by the in-vehicle camera 41. The eye position information acquisition unit 21 also analyzes the image corresponding to the detected position of the driver's eye 100 among images captured by the in-vehicle camera 41, and detects the direction of the driver's line of sight.

Note that the eye position information acquisition unit 21 may be included in the information source device 4, instead of the display control device 2. In that case, the eye position information acquisition unit 21 is formed with a driver monitoring system (DMS) that monitors the driver's condition, an occupant monitoring system (OMS) that monitors an occupant's condition, or the like.

The yawing information acquisition unit 22 acquires yawing information indicating the angle of the vehicle 1 in the traveling direction with respect to an expected traveling route of the vehicle 1. Yawing is rotation of the vehicle 1 about the vertical direction. The yawing information is the yaw angle (unit: deg) that is the rotation angle, or the yaw rate (unit: deg/sec) that is the amount of change in the yaw angle per unit time.

The expected traveling route is the traveling route of the vehicle 1, and includes the driving lane and the position of the vehicle 1 in the driving lane. For example, the yawing information acquisition unit 22 acquires route guidance information indicating the traveling direction at the next intersection from the navigation device 45, and calculates the traveling route of the vehicle 1 on the basis of the acquired route guidance information. The yawing information acquisition unit 22 also acquires vehicle position information from the GPS receiver 44 and map information including driving lane information from the navigation device 45, and, on the basis of these pieces of information, calculates the driving lane and the position of the vehicle 1 in the driving lane, for example. Further, the yawing information acquisition unit 22 acquires a captured image from the outside camera 42, detects a white line or a road shoulder or the like from the acquired image, and, on the basis of the relationship between the detected white line or the road shoulder or the like and the vehicle position, calculates the driving lane and the position of the vehicle 1 in the driving lane, for example. Note that the expected traveling route calculation method implemented by the yawing information acquisition unit 22 is not limited to the above example. Further, the yawing information acquisition unit 22 may acquire information indicating an expected traveling route not calculated by the yawing information acquisition unit 22. In that case, the navigation device 45 may independently calculate an expected traveling route, or the navigation device 45 may calculate an expected traveling route by acquiring information from one of the components of the information source device 4, for example.

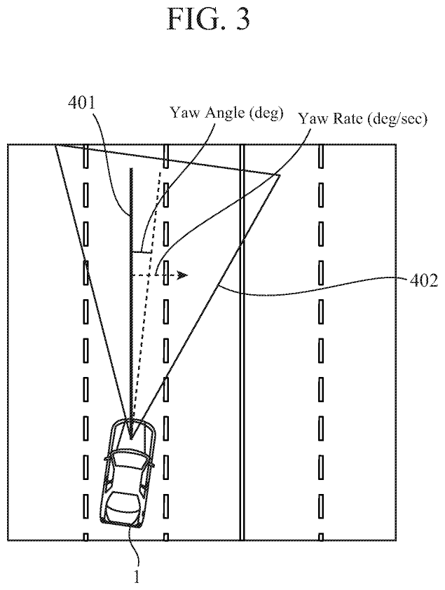

FIG. 3 is a diagram for explaining yawing information.

In the example shown in FIG. 3, the yawing information acquisition unit 22 sets an expected traveling route 401 as the yaw angle reference (0 degrees), and acquires a yaw angle that is the angle of the vehicle 1 in the traveling direction with respect to the expected traveling route 401. Alternatively, the yawing information acquisition unit 22 calculates a yaw rate, using the acquired yaw angle. The yaw angle and the yaw rate are positive values in the clockwise direction and are negative values in the counterclockwise direction with respect to the reference angle (0 degrees). In FIG. 3, a display area 402 corresponds to the area of the windshield 300 onto which the display device 3 can project the virtual image 200.

For example, the yawing information acquisition unit 22 calculates the yaw angle with respect to the expected traveling route 401, on the basis of the position or tilt of a white line or a road shoulder or the like detected from an image captured by the outside camera 42. Also, the yawing information acquisition unit 22 calculates the yaw angle by combining angular velocity detected by a sensor connected to the ECU 43 with the vehicle position information or the route guidance information described above, for example. Alternatively, the yawing information acquisition unit 22 may calculate a more accurate yaw angle by performing a statistical processing such as calculation of the mean value of yaw angles calculated by a plurality of calculation methods, taking into consideration the imaging cycle of the outside camera 42, the angular velocity detection cycle, the vehicle position acquisition cycle, and the like, as well as the accuracy of these pieces of information.

The deviation possibility prediction unit 23 predicts the possibility of deviation of the vehicle 1 from the expected traveling route 401, on the basis of the information acquired from the information source device 4. Deviation from the expected traveling route 401 is predicted from at least one piece of information among route guidance information acquired from the navigation device 45, driving lane information acquired from the navigation device 45 or the outside camera 42, obstacle information acquired from the outside camera 42 or the radar sensor 46, the driver's line-of-sight information acquired from the eye position information acquisition unit 21, blinker information acquired from a sensor connected to the ECU 43, and utterance information regarding an occupant of the vehicle 1 acquired from the in-vehicle microphone 48. The obstacle information is information indicating the positions of obstacles that are present around the vehicle 1 and hinder the traveling of the vehicle 1. The driver's line-of-sight information is information indicating the line-of-sight direction of the driver of the vehicle 1. The blinker information is information indicating whether or not the right blinker and the left blinker of the vehicle 1 are on.

For example, in a case where the route guidance information indicates “turn right at the next intersection”, and the driving lane information indicates “left lane” or “center lane”, the deviation possibility prediction unit 23 predicts that there is a high possibility that the vehicle 1 will change lanes to the right lane before entering the next intersection. For example, in a case where there is an obstacle that hinders the traveling on the expected traveling route 401, such as a parked vehicle ahead of the vehicle 1 in the driving lane, the deviation possibility prediction unit 23 predicts that there is a high possibility that the vehicle 1 will meander to avoid the obstacle. Depending on the position of the obstacle in the driving lane, the vehicle 1 might meander in the driving lane to avoid the obstacle, or the vehicle 1 might meander by entering an adjacent lane from the driving lane to avoid the obstacle, and returning to the driving lane after the avoidance. For example, in a case where the driver's line of sight is directed to a side mirror or backward, the deviation possibility prediction unit 23 predicts that the vehicle 1 is highly likely to change lanes. For example, in a case where the blinkers are on, the deviation possibility prediction unit 23 predicts that the vehicle 1 is highly likely to change lanes. For example, in a case where an occupant of the vehicle 1 utters “no cars are coming from behind, so change lanes to the right lane”, the deviation possibility prediction unit 23 predicts that the vehicle 1 is highly likely to change lanes.

The deviation possibility prediction unit 23 predicts a deviation possibility by the above prediction method. The deviation possibility prediction unit 23 may indicate the deviation possibility with a discrete value at two or more levels, such as “high”, “medium”, and “low”, or with a continuous value from “0%” to “100%”.

For example, in a case where the possibility of a lane change based on the route guidance information and the driving lane information is low, the deviation possibility prediction unit 23 predicts that the deviation possibility is “low”. In a case where the possibility of a lane change based on the route guidance information and the driving lane information is high, on the other hand, the deviation possibility prediction unit 23 predicts that the deviation possibility is “medium”. Further, in a case where the possibility of a lane change based on the route guidance information and the driving lane information is high, and the possibility of a lane change based on the blinker information is high, the deviation possibility prediction unit 23 predicts that the deviation possibility is “high”. In this manner, the deviation possibility prediction unit 23 may predict a deviation possibility, depending on the combination of prediction methods.

For example, in a case where the possibility of a lane change based on the route guidance information and the driving lane information is high, the deviation possibility prediction unit 23 adds “+30%” to the deviation possibility. Also, in a case where the possibility of a lane change based on the blinker information is high, the deviation possibility prediction unit 23 adds “+30%” to the deviation possibility. In this manner, the deviation possibility prediction unit 23 may add points by each predetermined prediction method, to predict a deviation possibility.

Further, to predict a deviation possibility, the deviation possibility prediction unit 23 may use past travel history information regarding the vehicle 1. For example, in a case where the route guidance information indicates “turn right at the next intersection”, and the driving lane information indicates “left lane” or “center lane”, the deviation possibility prediction unit 23 estimates that the frequency of a lane change to the right lane before the vehicle 1 enters the next intersection is high, on the basis of the travel history information. In this case, the deviation possibility prediction unit 23 adds “+40%”, which is higher than the normal “+30%”, to the deviation possibility.

Alternatively, the deviation possibility prediction unit 23 may predict a deviation possibility, using machine learning or the like.

The yawing change prediction unit 24 predicts a difference in position caused between a superimposition display object and the display object 201 in the horizontal direction by deviation of the vehicle 1 from the expected traveling route 401, on the basis of yawing information acquired by the yawing information acquisition unit 22, and the deviation possibility predicted by the deviation possibility prediction unit 23. On the basis of the predicted difference in position, the yawing change prediction unit 24 calculates a correction amount for superimposed display of the display object 201 on the superimposition display object. On the basis of the result of the prediction of the difference in position caused between the superimposition display object and the display object 201 in the horizontal direction by deviation of the vehicle 1 from the expected traveling route 401, the yawing change prediction unit 24 then instructs the image generation unit 25 to change the superimposition target on which the display object 201 is to be displayed in a superimposed manner, or correct the display mode of the display object 201.

The image generation unit 25 generates image information about the display object 201, and outputs the image information to the image display unit 31 of the display device 3, to cause the image display unit 31 to display this image information. For example, the image generation unit 25 acquires imaging information from the in-vehicle camera 41 and the outside camera 42, acquires the vehicle position information from the GPS receiver 44, acquires vehicle information from various sensors connected to the ECU 43, acquires the route guidance information from the navigation device 45, acquires the obstacle information from the radar sensor 46, and acquires facility information from the wireless communication device 47. The image generation unit 25 generates image information about the display object 201 indicating the traveling velocity of the vehicle 1 or a route guide arrow or the like, using at least one of these acquired pieces of information. Alternatively, the image generation unit 25 may generate image information about the display object 201 indicating the position of a superimposition target such as the driving lane or an obstacle, or related information about the superimposition target, using at least one of these acquired pieces of information.

At the time of image information generation, the image generation unit 25 changes the superimposition target or corrects the display mode of the display object 201, on the basis of an instruction from the yawing change prediction unit 24. In correcting the display mode, the image generation unit 25 corrects the position of the display object 201 on the basis of the correction amount calculated by the yawing change prediction unit 24, or switches the display object 201 from a displayed state to an undisplayed state, for example. The image generation unit 25 outputs the generated image information to the image display unit 31.

The display object 201 is an object such as a route guide arrow included in the image information, and is visually recognized as the virtual image 200 by the driver. The superimposition target is an object that is present in the foreground of the vehicle 1, and the display object 201 is to be superimposed on the superimposition target. The superimposition target is the next intersection to which the vehicle 1 is heading, another vehicle or a pedestrian present in the vicinity of the vehicle 1, a white line in the driving lane, a facility present in the vicinity of the vehicle 1, or the like.

The image generation unit 25 draws the display object 201 in an image at a position, in size, and with color so that the display object 201 of the virtual image 200 appears to be superimposed on the superimposition target, and sets the drawn image as the image information. Note that, in a case where the image display unit 31 can display a binocular parallax image, the image generation unit 25 may generate a binocular parallax image as the image information about the display object 201, with the display object being shifted to the right and left in the binocular parallax image.

In a case where the display device 3 has a configuration in which it is possible to adjust the position of the virtual image 200 by adjusting the tilt angle of the reflective minor 32 as shown in FIG. 1, the image generation unit 25 acquires virtual image position information indicating the position of the virtual image 200 depending on the tilt angle of the reflective mirror 32, from the virtual image position information acquisition unit 26. The image generation unit 25 then changes the position of the display object 201, on the basis of the acquired virtual image position information.

The virtual image position information acquisition unit 26 acquires reflective mirror angle information indicating the tilt angle of the reflective mirror 32, from the reflective mirror adjustment unit 33. The virtual image position information acquisition unit 26 has a database in which the correspondence relationship between the tilt angle of the reflective mirror 32 and the position of the virtual image 200 to be visually recognized by the driver is defined, for example. By referring to this database, the virtual image position information acquisition unit 26 identifies the position of the virtual image 200 depending on the tilt angle of the reflective mirror 32, and outputs the identified position as the virtual image position information to the image generation unit 25.

Note that the virtual image position information acquisition unit 26 identifies the position of the virtual image 200 on the basis of the tilt angle of the reflective mirror 32, but the position of the virtual image 200 may be identified by another method.

Further, in a case where the reflective mirror 32 is fixed, and its angle is not adjustable, the position of the virtual image 200 may be set beforehand in the virtual image position information acquisition unit 26 or the image generation unit 25. In a case where the position of the virtual image 200 is set beforehand in the image generation unit 25, the virtual image position information acquisition unit 26 is not necessary.

Next, operations of the display control device 2 are described.

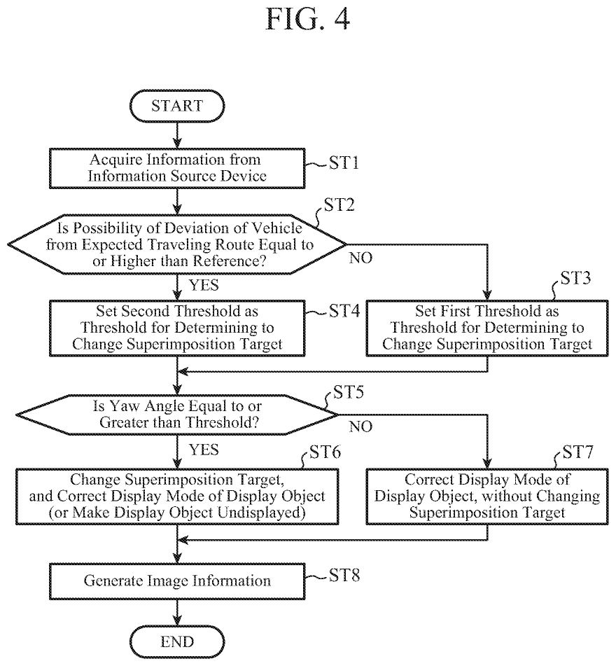

FIG. 4 is a flowchart showing example operations of the display control device 2 according to the first embodiment. The display control device 2 starts the operation shown in the flowchart in FIG. 4 when the ignition switch of the vehicle 1 is turned on, and repeats this operation until the ignition switch is turned off, for example.

In step ST1, the display control device 2 acquires various kinds of information from the information source device 4. For example, the eye position information acquisition unit 21 acquires a captured image from the in-vehicle camera 41, and acquires the driver's eye position information and line-of-sight information, using the acquired captured image. Also, the yawing information acquisition unit 22 acquires information from at least one device among the outside camera 42, the ECU 43, the GPS receiver 44, and the navigation device 45, and calculates the expected traveling route 401 and the yawing information, using the acquired information.

In the description below, the yawing information acquisition unit 22 calculates a yaw angle as the yawing information.

In step ST2, the deviation possibility prediction unit 23 predicts a possibility of deviation of the vehicle 1 from the expected traveling route 401, using at least one piece of information among the line-of-sight information, the utterance information, and the traffic information acquired from the information source device 4 in step ST1. The traffic information includes at least one piece of information among the route guidance information, the driving lane information, and the obstacle information.

If the deviation possibility predicted by the deviation possibility prediction unit 23 is lower than a predetermined reference (“NO” in step ST2), the yawing change prediction unit 24 performs the operation of step ST3. In a case where the deviation possibility is lower than the above reference, the vehicle 1 is traveling along the expected traveling route 401. If the deviation possibility predicted by the deviation possibility prediction unit 23 is equal to or higher than the above reference (“YES” in step ST2), the yawing change prediction unit 24 performs the operation of step ST4. In a case where the deviation possibility is equal to or higher than the above reference, the vehicle 1 is likely to deviate from the expected traveling route 401.

In step ST3, the yawing change prediction unit 24 sets a first threshold as the yawing information threshold for determining to change the superimposition target. Note that the value of the first threshold may be a fixed value, or may be a variable value that changes with the deviation possibility or the like. This first threshold is the threshold for determining that the vehicle 1 has deviated from the expected traveling route 401 and for determining to change the superimposition target, in a situation where the deviation possibility is lower than the reference and the vehicle 1 is traveling along the road shape. In a case where the possibility of deviation of the vehicle 1 from the expected traveling route 401 is low, the change in the yaw angle of the vehicle 1 is small, because the driver drives along the road shape while finely adjusting the yaw angle of the vehicle 1. In the first embodiment, when the yaw angle of the vehicle 1 changes with the driver's operation and the road shape, the superimposition target is not changed. When the yaw angle of the vehicle 1 changes with a lane change or obstacle avoidance, the superimposition target is changed. Therefore, the first threshold is set at a value that is greater than the amount of change caused in the yaw angle of the vehicle 1 by the driver's operation and the road shape, but is smaller than the amount of change caused in the yaw angle of the vehicle 1 by a lane change or obstacle avoidance.

In step ST4, the yawing change prediction unit 24 sets a second threshold as the yawing information threshold for determining to change the superimposition target. Note that the value of the second threshold may be a fixed value, or may be a variable value that changes with the deviation possibility or the like. This second threshold is the threshold for determining that the vehicle 1 has deviated from the expected traveling route 401 and for determining to change the superimposition target, in a situation where the deviation possibility is equal to or higher than the reference and the vehicle 1 is likely to deviate from the expected traveling route 401. In a case where the possibility of deviation of the vehicle 1 from the expected traveling route 401 is high, the change in the yaw angle of the vehicle 1 becomes larger at a time when the vehicle 1 changes lanes or avoids an obstacle. In the first embodiment, the absolute value of the second threshold is set at a smaller value than the absolute value of the first threshold, so that a start of a lane change or obstacle avoidance by the vehicle 1 can be detected.

Note that, in a case where the first threshold and the second threshold are variable values, the yawing change prediction unit 24 sets a value depending on the driving characteristics of the driver, using the past travel history information regarding each driver, for example. Further, the yawing change prediction unit 24 may cause the value to differ between a lane change and obstacle avoidance.

In step ST5, if the yaw angle acquired from the yawing information acquisition unit 22 is equal to or greater than the first threshold set in step ST3, or is equal to or greater than the second threshold set in step ST4 (“YES” in step ST5), the yawing change prediction unit 24 performs the operation of step ST6. If the yaw angle acquired from the yawing information acquisition unit 22 is smaller than the first threshold set in step ST3, or is smaller than the second threshold set in step ST4 (“NO” in step ST5), on the other hand, the yawing change prediction unit 24 performs the operation of step ST7.

In step ST6, the yawing change prediction unit 24 determines that the vehicle 1 has deviated from the expected traveling route 401, and acquires an expected traveling route 401 on which the vehicle 1 is expected to travel after the deviation (this route will be hereinafter referred to as the “expected traveling route 401 after the change”), from the yawing information acquisition unit 22. Further, to correct the difference in position caused between the display object 201 and the superimposition target in the horizontal direction by deviation of the vehicle 1 from the expected traveling route 401, the yawing change prediction unit 24 instructs the image generation unit 25 to change the superimposition target on the basis of the expected traveling route 401 after the change, and to correct the display mode of the display object 201 to match the changed superimposition target. Note that, in a case where the difference between the yaw angle and the first threshold, or the difference between the yaw angle and the second threshold is equal to or larger than a predetermined value, or where the superimposition target is present outside the display area 402 of the image display unit 31 due to deviation of the vehicle 1 from the expected traveling route 401, the yawing change prediction unit 24 may instruct the image generation unit 25 to put the display object 201 into an undisplayed state, instead of to change the superimposition target.

In step ST7, the yawing change prediction unit 24 instructs the image generation unit 25 to correct the display mode of the display object 201 so as to eliminate the difference in position caused between the display object 201 and the superimposition target in the horizontal direction by the driver's driving operation or the road shape. Note that, in step ST7, the yawing change prediction unit 24 does not change the superimposition target, because the vehicle 1 has not deviated from the expected traveling route 401.

In step ST8, the image generation unit 25 generates image information about the display object 201, using the various kinds of information acquired from the information source device 4. The image generation unit 25 also corrects the display mode such as the position and the size of the display object 201 so that the display object 201 is superimposed on the superimposition target designated by the yawing change prediction unit 24. For example, in a case where the correction amount for correcting a difference in position between the superimposition target and the display object 201 in the horizontal direction is designated, the image generation unit 25 acquires the yaw angle from the yawing information acquisition unit 22, and corrects the position of the display object 201, using the acquired yaw angle and the above correction amount. The image generation unit 25 then outputs the image information about the display object 201 to the image display unit 31, to cause the image display unit 31 to project the image information onto the windshield 300. Note that, in a case where the display device 3 is already displaying the image information about the display object 201, the image generation unit 25 corrects the display object 201 in the image information in accordance with an instruction from the yawing change prediction unit 24.

Next, the difference between a case where there is only one threshold for changing the superimposition target and a case where there are two thresholds that are the first threshold and the second threshold is described. In the description below, the case where there is only one threshold for changing the superimposition target will be referred to as the “reference example”, and the first threshold will be mentioned as this threshold.

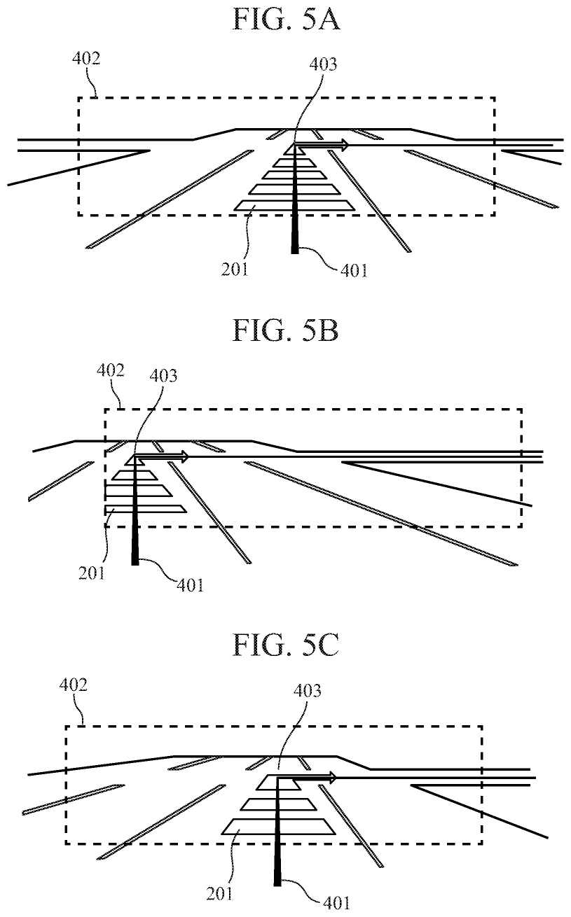

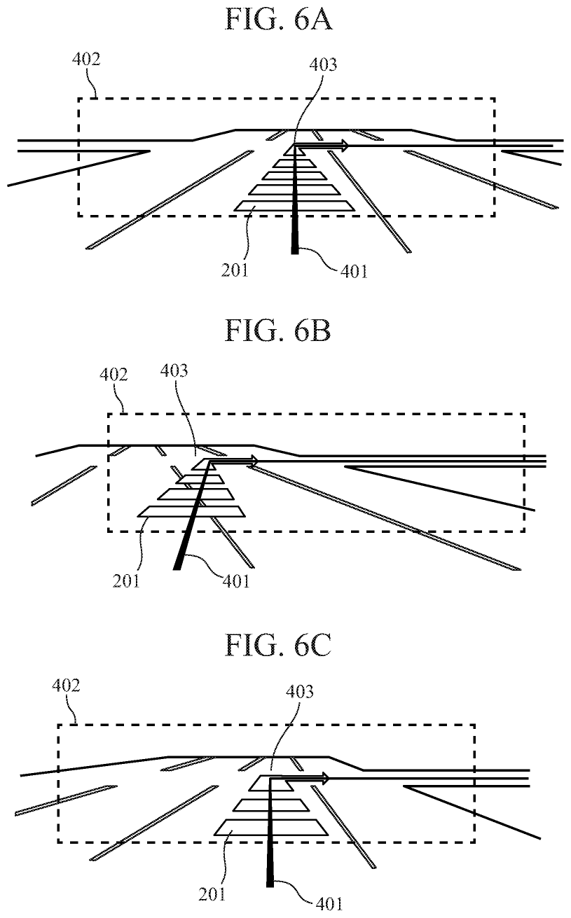

FIGS. 5A, 5B, and 5C are diagrams showing the foreground from the driver's viewpoint, and illustrate the reference example for facilitating understanding of the display system according to the first embodiment. FIGS. 6A, 6B, and 6C are diagrams showing the foreground from the driver's viewpoint in the display system according to the first embodiment. FIGS. 5A and 6A each show the foreground from the driver's viewpoint before a lane change. FIGS. 5B and 6B each show the foreground from the driver's viewpoint during the lane change. FIGS. 5C and 6C each show the foreground from the driver's viewpoint after the lane change.

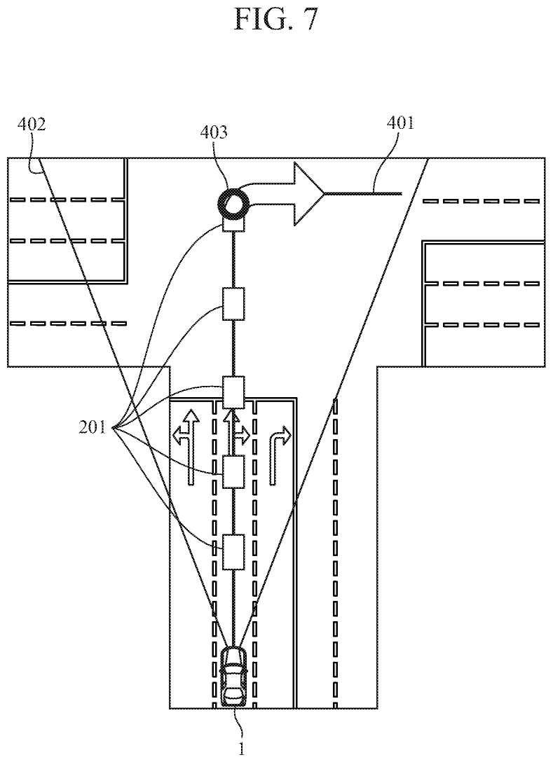

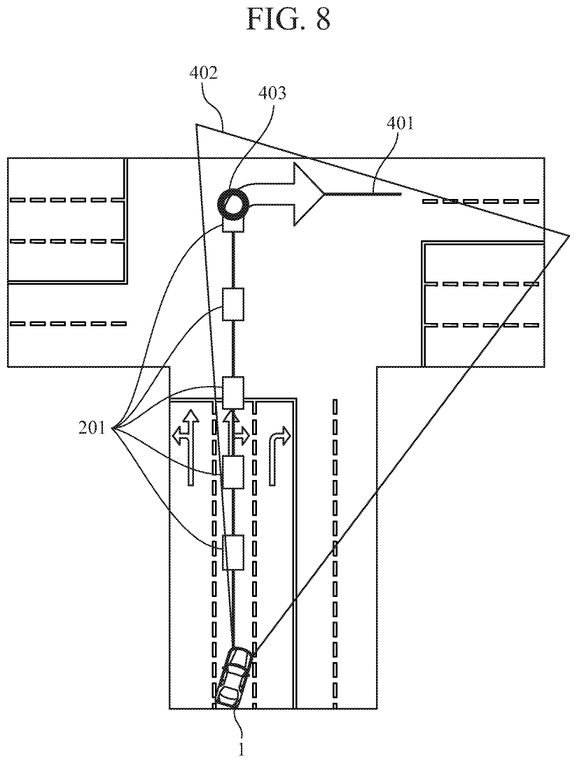

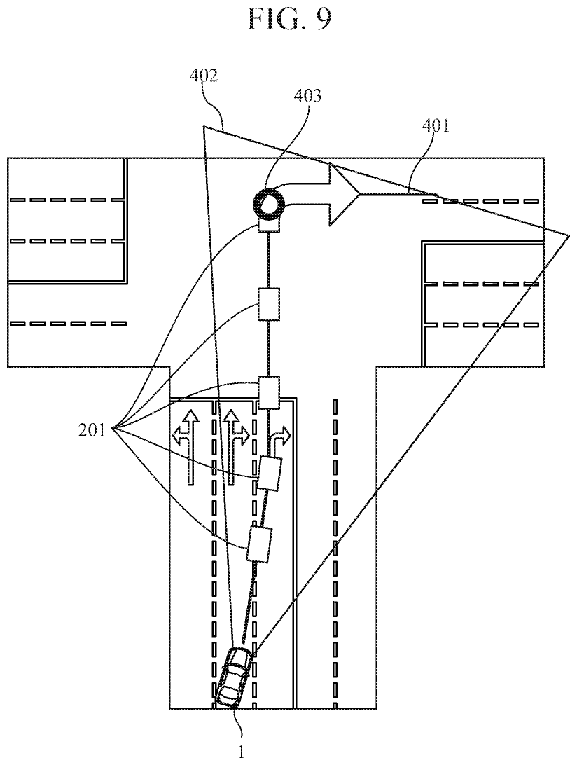

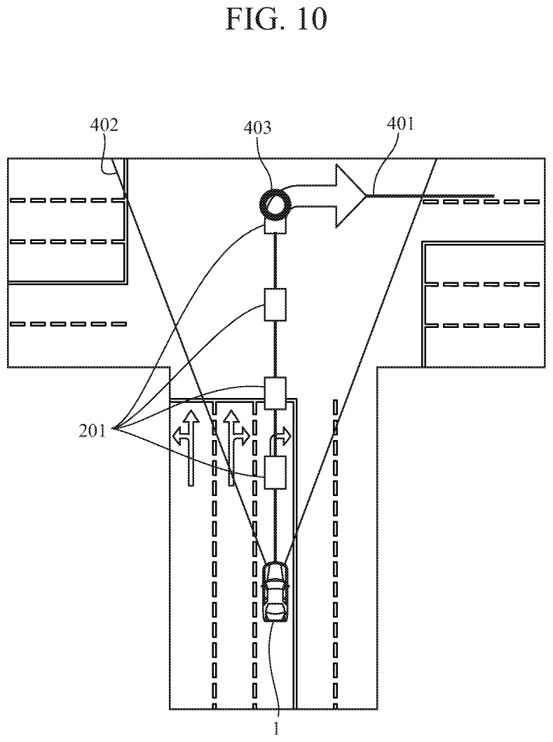

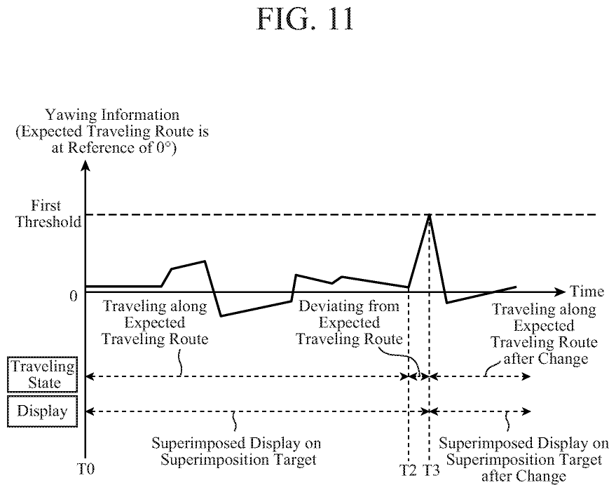

FIG. 7 is a bird's-eye view showing the situations illustrated in FIGS. 5A and 6A. FIG. 8 is a bird's-eye view showing the situation illustrated in FIG. 5B. FIG. 9 is a bird's-eye view showing the situation illustrated in FIG. 6B. FIG. 10 is a bird's-eye view showing the situations illustrated in FIGS. 5C and 6C.

FIG. 11 is a chart showing changes in yawing at a time of deviation from the expected traveling route, and is a reference example for facilitating understanding of the display system according to the first embodiment. FIG. 12 is a chart showing changes in yawing at a time of deviation from the expected traveling route in the display system according to the first embodiment.

Note that, in FIGS. 11 and 12, only the first threshold and the second threshold that are positive values are shown, and the first threshold and the second threshold that are negative values are not shown. The absolute value of the positive first threshold and the absolute value of the negative first threshold may be the same or may be different. Likewise, the absolute value of the positive second threshold and the absolute value of the negative second threshold may be the same or may be different.

First, the reference example is described.

In the reference example, a superimposition target 403 (an intersection in the center lane, for example) is seen through the windshield 300 in the display area 402 of the windshield 300, as shown in FIG. 5A. In the display area 402, the display object 201 (a route guide arrow, for example) that is a virtual image is superimposed and displayed on the superimposition target 403. Meanwhile, as shown in FIG. 7, the vehicle 1 is traveling in the center lane along the expected traveling route 401 (time T0 to time T2 in FIG. 11).

As shown in FIG. 8, the vehicle 1 starts changing lanes from the center lane to the right lane, to turn right at the intersection in accordance with the expected traveling route 401 (time T2 in FIG. 11). Because the yaw angle that has changed with the lane change is smaller than the first threshold, the display object 201 remains superimposed and displayed on the superimposition target 403 as shown in FIG. 5B. On the other hand, the display area 402 moves to the right as the vehicle 1 changes lanes. Therefore, in FIG. 5B, the display object 201 moves in the direction opposite from the traveling direction of the vehicle 1, and might hinder the driving. Also, part of the display object 201 is not displayed because it is now outside the display area 402. Therefore, there is a possibility that the information originally indicated by the display object 201 cannot be correctly conveyed to the driver.

In a case where the yaw angle becomes equal to or greater than the first threshold (time T3 in FIG. 11) after the start of the lane change (time T2 in FIG. 11), the yawing change prediction unit 24 determines that deviation from the expected traveling route 401 has occurred. At this time T3, the yawing change prediction unit 24 determines that it is necessary to change the expected traveling route 401 and the superimposition target 403. The yawing change prediction unit 24 then instructs the image generation unit 25 to change the superimposition target 403, on the basis of the expected traveling route 401 after the change, the amount of change in the yaw angle, and the like. Upon receipt of the instruction from the yawing change prediction unit 24, the image generation unit 25 changes the superimposition target 403 from an intersection in the center lane, which is the expected traveling route 401 before the change, to an intersection in the right lane, which is the expected traveling route 401 after the change, on the basis of the amount of change in the yaw angle and the like. Accordingly, the display object 201 is superimposed and displayed on the superimposition target 403, which is an intersection in the right lane, as shown in FIGS. 5C and 10. The vehicle 1 travels in the right lane along the expected traveling route 401. At time T3 in FIG. 11, the foreground from the driver's viewpoint changes from the one shown in FIG. 5B to the one shown FIG. 5C, and the display object 201 suddenly moves from the center lane to the right lane, which might hinder the driving.

As described above, in a case where there is only one threshold for changing the superimposition target, a great value needs to be set as the threshold, to distinguish a yaw angle change for traveling along the road shape from a yaw angle change caused by deviation of the vehicle 1 from the expected traveling route 401. Therefore, a delay is caused in determining to change lanes or avoid an obstacle. Further, even if the orientations of the vehicle 1 are the same as shown in FIGS. 8 and 9, the timing to change the expected traveling route 401 is delayed in the case where there is only one threshold. Therefore, the yaw angles after time T2 and T12 are different. As a result, in the case where there is only one threshold, the difference in display position between the display object 201 and the superimposition target 403 cannot be appropriately corrected, and the visibility of the foreground including the display object 201 is degraded.

Next, an example of the first embodiment is described.

In the first embodiment, the superimposition target 403 (an intersection in the center lane, for example) is seen through the windshield 300 in the display area 402 of the windshield 300, as shown in FIG. 6A. In the display area 402, the display object 201 (a route guide arrow, for example) that is a virtual image is superimposed and displayed on the superimposition target 403. Meanwhile, as shown in FIG. 7, the vehicle 1 is traveling in the center lane along the expected traveling route 401 (time T10 to time T12 in FIG. 12).

The deviation possibility prediction unit 23 predicts that the deviation possibility is high before the intersection, because the vehicle 1 is to change lanes from the center lane to the right lane to turn right at the intersection in accordance with the expected traveling route 401. As the deviation possibility is equal to or higher than the reference, the yawing change prediction unit 24 sets the second threshold as the threshold for determining to change the superimposition target (time T11 in FIG. 12).

As shown in FIG. 9, the vehicle 1 starts changing lanes from the center lane to the right lane, to turn right at the intersection in accordance with the expected traveling route 401 (time T12 in FIG. 12). As the yaw angle that has changed with the lane change quickly becomes equal to or higher than the second threshold (time T13 in FIG. 12), the yawing change prediction unit 24 determines that deviation from the expected traveling route 401 has occurred. At this time T13, the yawing change prediction unit 24 determines that it is necessary to change the expected traveling route 401 and the superimposition target 403. The yawing change prediction unit 24 then instructs the image generation unit 25 to change the superimposition target 403, on the basis of the expected traveling route 401 after the change, the amount of change in the yaw angle, and the like. Further, on the basis of the amount of change in the yaw angle and the like, the yawing change prediction unit 24 calculates the correction amount for the difference in position in the horizontal direction between the superimposition target 403 after the change and the display object 201, and informs the image generation unit 25 of the correction amount. Upon receipt of an instruction from the yawing change prediction unit 24, the image generation unit 25 changes the superimposition target 403 from the intersection in the center lane to an intersection in the right lane, on the basis of the amount of change in the yaw angle and the like (time T13 in FIG. 12). The image generation unit 25 also corrects the display mode of the display object 201 as shown in FIGS. 6B and 9, on the basis of the correction amount designated by the yawing change prediction unit 24. Accordingly, the display object 201 moves in the same direction as the traveling direction of the vehicle 1, and the display object 201 does not move out of the display area 402. Also, the foreground from the driver's viewpoint changes from the one shown in FIG. 6B to the one shown in FIG. 6C, and sudden movement of the display object 201 is prevented.

As described above, the display control device 2 according to the first embodiment includes the yawing information acquisition unit 22, the deviation possibility prediction unit 23, the yawing change prediction unit 24, and the image generation unit 25. The yawing information acquisition unit 22 acquires the yaw angle or the yaw rate of the vehicle 1 as yawing information. The deviation possibility prediction unit 23 predicts a possibility of deviation of the vehicle 1 from the expected traveling route 401, using at least one piece of information among line-of-sight information about an occupant of the vehicle 1, utterance information about the occupant, and traffic information. The yawing change prediction unit 24 detects deviation of the vehicle 1 from the expected traveling route 401, using the yawing information and the deviation possibility. In a case where the yawing change prediction unit 24 has detected deviation of the vehicle 1 from the expected traveling route 401, the image generation unit 25 changes the superimposition target 403, and corrects the difference in position between the superimposition target 403 after the change and the display object 201. In this manner, the display control device 2 can detect deviation of the vehicle 1 from the expected traveling route 401, using the yaw angle or the yaw rate, and the deviation possibility predicted with the use of at least one piece of information among the line-of-sight information, the utterance information, and the traffic information. The display control device 2 can also prevent problems such as the problems (1), (2), and (3) described above, by changing the superimposition target 403 when deviation is detected, and correcting the difference in position in the horizontal direction between the superimposition target 403 after the change and the display object 201. Thus, the display control device 2 can correct the difference in position in the horizontal direction between the display object 201 and the superimposition target 403 in a case where the vehicle 1 has deviated from the expected traveling route 401.

Also, according to the first embodiment, in a case where the deviation possibility predicted by the deviation possibility prediction unit 23 is lower than the predetermined reference (“NO” in step ST2 in FIG. 4), the yawing change prediction unit 24 sets the first threshold as the threshold for determining to change the superimposition target (step ST3 in FIG. 4). In a case where the yawing information acquired by the yawing information acquisition unit 22 is equal to or greater than the first threshold (“YES” in step ST5 in FIG. 4), the yawing change prediction unit 24 then instructs the image generation unit 25 to change the superimposition target 403 or make the display object 201 undisplayed (step ST6 in FIG. 4). Thus, the display control device 2 can detect deviation of the vehicle 1 from the expected traveling route 401 even in a case where the deviation possibility is low. Further, the display control device 2 does not make any correction for maintaining the superimposed display of the superimposition target 403 and the display object 201 before the change at the time of the deviation detection, but changes the superimposition target 403 or makes the display object 201 undisplayed. Thus, display without any unnaturalness can be performed.

Further, according to the first embodiment, in a case where the deviation possibility predicted by the deviation possibility prediction unit 23 is equal to or higher than the predetermined reference (“YES” in step ST2 in FIG. 4), the yawing change prediction unit 24 sets the second threshold as the threshold for determining to change the superimposition target (step ST4 in FIG. 4). In a case where the yawing information acquired by the yawing information acquisition unit 22 is equal to or greater than the second threshold (“YES” in step ST5 in FIG. 4), the yawing change prediction unit 24 then instructs the image generation unit 25 to change the superimposition target 403 or make the display object 201 undisplayed (step ST6 in FIG. 4). As a result, in a case where the deviation possibility is high, the display control device 2 can detect a start of deviation of the vehicle 1 from the expected traveling route 401, using the second threshold, which is smaller than the first threshold. Further, the display control device 2 does not make any correction for maintaining the superimposed display of the superimposition target 403 and the display object 201 before the change at the time of the deviation start detection, but changes the superimposition target 403 or makes the display object 201 undisplayed. Thus, display without any unnaturalness can be performed.

Also, according to the first embodiment, in a case where the deviation possibility predicted by the deviation possibility prediction unit 23 is lower than the predetermined reference (“NO” in step ST2 in FIG. 4), and the yawing information acquired by the yawing information acquisition unit 22 is smaller than the first threshold (“NO” in step ST5 in FIG. 4), the yawing change prediction unit 24 instructs the image generation unit 25 to correct the difference in position between the superimposition target 403 and the display object 201 (step ST7 in FIG. 4).

Further, in a case where the deviation possibility predicted by the deviation possibility prediction unit 23 is equal to or higher than the predetermined reference (“YES” in step ST2 in FIG. 4), and the yawing information acquired by the yawing information acquisition unit 22 is smaller than the second threshold (“NO” in step ST5 in FIG. 4), the yawing change prediction unit 24 instructs the image generation unit 25 to correct the difference in position between the superimposition target 403 and the display object 201 (step ST7 in FIG. 4).

In either case, the display control device 2 can make correction for maintaining the superimposed display of the display object 201 on the superimposition target 403 while the vehicle 1 is traveling along the expected traveling route 401. Thus, display without any unnaturalness can be performed.

Next, a modification of the display control device 2 according to the first embodiment is described.

The yawing change prediction unit 24 of the first embodiment uses a yaw angle as yawing information, and sets a first threshold and a second threshold that match the value of the yaw angle. However, a yaw rate may be used as yawing information, and the first threshold and the second threshold that match the value of the yaw rate may be set. In the case of this modification, if the yaw rate is equal to or higher than the first threshold or the second threshold in step ST5 in FIG. 4, the yawing change prediction unit 24 determines that the vehicle 1 has deviated from the expected traveling route 401. In the case where the yaw rate is used, it is possible to detect a start of deviation of the vehicle 1 from the expected traveling route 401 more quickly than in a case where the yaw angle is used, and it might also be possible to change the superimposition target 403 more quickly.

In a modification of the first embodiment, if the deviation possibility predicted by the deviation possibility prediction unit 23 is equal to or higher than the predetermined reference (“YES” in step ST2 in FIG. 4), that is, if the possibility of deviation of the vehicle 1 from the expected traveling route 401 is high, the yawing change prediction unit 24 instructs the image generation unit 25 to temporarily stop the correction of the difference in position between the superimposition target 403 and the display object 201. After that, when the superimposition target 403 after a change enters the display area 402, or when the superimposition target 403 after the change and the display object 201 come close to each other within a predetermined distance, the yawing change prediction unit 24 instructs the image generation unit 25 to resume the correction of the difference in position between the superimposition target 403 after the change and the display object 201. In the case of this modification, movement of the display object caused by a change of the superimposition target occurs in accordance with a change in the yaw angle, and thus, display without any unnaturalness can be performed.

In a modification of the first embodiment, in a case where the deviation possibility is equal to or higher than the reference, and the possibility of deviation of the vehicle 1 from the expected traveling route 401 is high, the yawing change prediction unit 24 predicts the superimposition target 403 after a change at that point of time (time T11 in FIG. 12). Also, in a case where the yawing change prediction unit 24 determines that the deviation possibility is equal to or higher than the reference, and predicts that the possibility of deviation of the vehicle 1 from the expected traveling route 401 is high, the yawing information acquisition unit 22 also predicts the expected traveling route 401 after a change at that point of time (time T11 in FIG. 12). In the case of this modification, the time until the image generation unit 25 corrects the display object 201 can be made shorter than in a case where the superimposition target 403 and the expected traveling route 401 after a change are calculated when the yawing information is determined to be equal to or greater than the first threshold or the second threshold after the vehicle 1 starts deviating from the expected traveling route 401. Note that the superimposition target 403 and the expected traveling route 401 after the change are predicted with the use of at least one piece of information among yawing information, line-of-sight information, utterance information, traffic information, and other various kinds of information.

In a modification of the first embodiment, the image generation unit 25 predicts the position of the vehicle 1 at the time of display of the display object 201, on the basis of vehicle velocity and yawing information. The image generation unit 25 corrects the position of the display object 201, taking into consideration the difference between the position of the vehicle 1 at the time when each component of the display control device 2 acquires information in step ST1 in FIG. 4, and the predicted position of the vehicle 1 at the time when image information is generated and is displayed on the image display unit 31 in step ST8. In the case of this modification, it is possible to correct the difference in position caused between the display object 201 and the superimposition target 403 when the vehicle 1 is traveling.

Note that, in the first embodiment, the display system provided for the driver has been described as an example. However, the display system may be provided for an occupant other than the driver.

Also, in the first embodiment, the display device 3 is a HUD, a HMD, or the like, but may be a center display or the like installed on the dashboard of the vehicle 1. The center display superimposes image information about the display object 201 generated by the image generation unit 25 of the display control device 2, on an image of the foreground of the vehicle 1 captured by the outside camera 42. As described above, the display device 3 is only required to be capable of superimposing the display object 201 on the foreground of the vehicle 1 through the windshield 300 or the foreground captured by the outside camera 42.

Lastly, the hardware configuration of the display system according to the first embodiment is described.

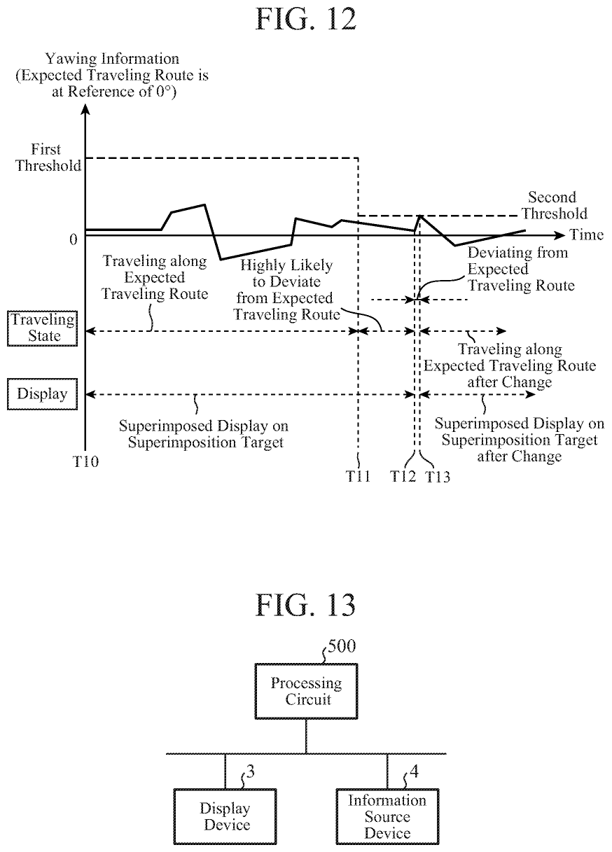

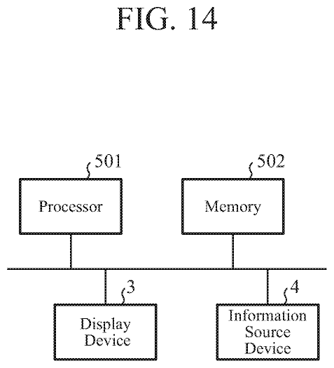

FIG. 13 is a diagram showing an example hardware configuration of the display system according to the first embodiment. In FIG. 13, a processing circuit 500 is connected to the display device 3 and the information source device 4, and can exchange information. FIG. 14 is a diagram showing another example hardware configuration of the display system according to the first embodiment. In FIG. 14, a processor 501 and a memory 502 are both connected to the display device 3 and the information source device 4. The processor 501 is capable of exchanging information with the display device 3 and the information source device 4.

The functions of the eye position information acquisition unit 21, the yawing information acquisition unit 22, the deviation possibility prediction unit 23, the yawing change prediction unit 24, the image generation unit 25, and the virtual image position information acquisition unit 26 in the display control device 2 are achieved with a processing circuit. That is, the display control device 2 includes a processing circuit for achieving the above functions. The processing circuit may be the processing circuit 500 as dedicated hardware, or may be the processor 501 that executes a program stored in the memory 502.

In a case where the processing circuit is dedicated hardware as shown in FIG. 13, the processing circuit 500 may be a single circuit, a composite circuit, a programmed processor, a parallel-programmed processor, an application specific integrated circuit (ASICs), a field-programmable gate array (FPGAs), or a combination thereof, for example. The functions of the eye position information acquisition unit 21, the yawing information acquisition unit 22, the deviation possibility prediction unit 23, the yawing change prediction unit 24, the image generation unit 25, and the virtual image position information acquisition unit 26 may be achieved with a plurality of processing circuits 500, or the functions of the respective components may be achieved with one processing circuit 500.

In a case where the processing circuit is the processor 501 as shown in FIG. 14, the functions of the eye position information acquisition unit 21, the yawing information acquisition unit 22, the deviation possibility prediction unit 23, the yawing change prediction unit 24, the image generation unit 25, and the virtual image position information acquisition unit 26 are achieved with software, firmware or a combination of software and firmware. Software or firmware is written as a program, and is stored in the memory 502. The processor 501 achieves the functions of the respective components by reading and executing the program stored in the memory 502. That is, the display control device 2 includes the memory 502 for storing a program for eventually carrying out the steps shown in the flowchart in FIG. 4 when executed by the processor 501. This program can also be regarded as a program for causing a computer to carry out or implement the procedures or the methods adopted by the eye position information acquisition unit 21, the yawing information acquisition unit 22, the deviation possibility prediction unit 23, the yawing change prediction unit 24, the image generation unit 25, and the virtual image position information acquisition unit 26.

Here, the processor 501 is a central processing unit (CPU), a processing unit, an arithmetic unit, a microprocessor, or the like.

The memory 502 may be a nonvolatile or volatile semiconductor memory such as a random access memory (RAM), a read only memory (ROM), an erasable programmable ROM (EPROM), or a flash memory, may be a magnetic disk such as a hard disk or a flexible disk, or may be an optical disk such as a compact disc (CD) or a digital versatile disc (DVD).

Note that some of the functions of the eye position information acquisition unit 21, the yawing information acquisition unit 22, the deviation possibility prediction unit 23, the yawing change prediction unit 24, the image generation unit 25, and the virtual image position information acquisition unit 26 may be achieved with dedicated hardware, and some of these functions may be achieved with software or firmware. For example, the functions of the eye position information acquisition unit 21 are achieved with dedicated hardware, and the functions of the yawing information acquisition unit 22, the deviation possibility prediction unit 23, the yawing change prediction unit 24, the image generation unit 25, and the virtual image position information acquisition unit 26 are achieved with software or firmware. In this manner, the processing circuit in the display control device 2 can achieve the above functions with hardware, software, firmware, or a combination thereof.

Within the scope of the present invention, modifications may be made to any component of the embodiment, or any component may be omitted from the embodiment.

### INDUSTRIAL APPLICABILITY

A display control device according to the present invention is designed to correct a difference in position in the horizontal direction between a display object and a superimposition target, and accordingly, is suitable as a display control device that controls a HUD and the like installed in a vehicle.

### REFERENCE SIGNS LIST

1: vehicle, 2: display control device, 3: display device, 4: information source device, 21: eye position information acquisition unit, 22: yawing information acquisition unit, 23: deviation possibility prediction unit, 24: yawing change prediction unit, 25: image generation unit, 26: virtual image position information acquisition unit, 31: image display unit, 32: reflective mirror, 33: reflective mirror adjustment unit, 41: in-vehicle camera, 42: outside camera, 43: ECU, 44: GPS receiver, 45: navigation device, 46: radar sensor, 47: wireless communication device, 48: in-vehicle microphone, 100: driver's eye, 200: virtual image, 201: display object, 300: windshield, 401: expected traveling route, 402: display area, 403: superimposition target, 500: processing circuit, 501: processor, 502: memory

1. A display control device that controls a display device that superimposes and displays a display object on a superimposition target ahead of a vehicle,
the display control device comprising:
processing circuitry configured to
acquire yawing information, the yawing information being a yaw angle that is an angle of an actual traveling direction of the vehicle with respect to an expected traveling route on which the vehicle is to travel, or a yaw rate that is an amount of change in the yaw angle per unit time;
predict possibility of deviation of the vehicle from the expected traveling route, using at least one piece of information among line-of-sight information about an occupant of the vehicle, utterance information about the occupant, and traffic information;
determine deviation of the vehicle from the expected traveling route, using the acquired yawing information, and the predicted possibility of deviation; and
change the superimposition target and correct a difference in position between the superimposition target after the change and the display object, when the processing circuitry determines the deviation of the vehicle from the expected traveling route.

2. The display control device according to claim 1, wherein the traffic information is at least one piece of information among route guidance information output by a navigation device, lane information regarding a lane in which the vehicle is traveling, and obstacle information regarding an obstacle present around the vehicle.

3. The display control device according to claim 1, wherein,
when the predicted possibility of deviation is lower than a predetermined reference, the yawing change prediction unit processing circuitry sets a first threshold as a threshold for determining whether to change the superimposition target, and,
when the acquired yawing information is equal to or greater than the first threshold, the processing circuitry changes the superimposition target or make the display object undisplayed.

4. The display control device according to claim 3, wherein,
when the predicted possibility of deviation is equal to or higher than the predetermined reference, the processing circuitry sets a second threshold as the threshold for determining whether to change the superimposition target, the second threshold being smaller than the first threshold, and,
when the acquired yawing information is equal to or greater than the second threshold, the processing circuitry changes the superimposition target or make the display object undisplayed.

5. The display control device according to claim 3, wherein,
when the predicted possibility of deviation is lower than the predetermined reference, and the acquired yawing information is smaller than the first threshold, the processing circuitry corrects a difference in position between the superimposition target and the display object.

6. The display control device according to claim 4, wherein,
when the predicted possibility of deviation is equal to or higher than the predetermined reference, and the acquired yawing information is smaller than the second threshold, the processing circuitry corrects a difference in position between the superimposition target and the display object.

7. The display control device according to claim 4, wherein,
when the predicted possibility of deviation is equal to or higher than the predetermined reference, the processing circuitry does not correct a difference in position between the superimposition target and the display object, and,
when the superimposition target after the change and the display object come within a predetermined distance from each other, the processing circuitry corrects a difference in position between the superimposition target after the change and the display object.

8. A display control method for controlling a display device that superimposes and displays a display object on a superimposition target ahead of a vehicle,
the display control method comprising:
acquiring yawing information, the yawing information being a yaw angle that is an angle of an actual traveling direction of the vehicle with respect to an expected traveling route on which the vehicle is to travel, or a yaw rate that is an amount of change in the yaw angle per unit time;
predicting a possibility of deviation of the vehicle from the expected traveling route, using at least one piece of information among line-of-sight information about an occupant of the vehicle, utterance information about the occupant, and traffic information;
determining deviation of the vehicle from the expected traveling route, using the acquired yawing information, and the predicted possibility of deviation; and
changing the superimposition target and correcting a difference in position between the superimposition target after the change and the display object, when the deviation of the vehicle from the expected traveling route is determined.
